(19) United States
(12) Patent Application Publication
(10) Pub. No.: US 2025/0370947 A1
(43) Pub. Date: Dec. 4, 2025

(54) MEMORY PROTOCOLS OVER OFF-PACKAGE INTERCONNECTS

(71) Applicants: Swadesh CHOUDHARY, Mountain View, CA (US); Debendra DAS SHARMA, Saratoga, CA (US)

(72) Inventors: Swadesh CHOUDHARY, Mountain View, CA (US); Debendra DAS SHARMA, Saratoga, CA (US)

(21) Appl. No.: 19/299,516

(22) Filed: Aug. 14, 2025

Related U.S. Application Data
(60) Provisional application No. 63/683,023, filed on Aug. 14, 2024.

(51) Int. Cl. G06F 13/38; G06F 11/10; G06F 13/16

(52) U.S. Cl. CPC G06F 13/387; G06F 11/1004; G06F 13/1673

(57) ABSTRACT

This disclosure describes systems, methods, and devices related to enhanced tunneled synchronization. A device may receive based on a command from a system-on-chip (SoC) device, at a memory buffer die, a plurality of command signals and associated data signals over a high-speed serial interface. The device may translate the plurality of command signals and associated data signals, at the memory buffer die, into memory protocol signals compatible with a plurality of dynamic random-access memory (DRAM) devices. The device may apply forward error correction (FEC) and cyclic redundancy check (CRC) algorithms to the command signals, data signals, and metadata at the memory buffer die. The device may transmit based on the memory protocol signals, from the memory buffer die to the DRAM devices, the corresponding data and command instructions.

### CROSS-REFERENCE TO RELATED APPLICATION(S)

This application claims the benefit of U.S. Provisional Application No. 63/683,023, filed Aug. 14, 2024, the disclosure of which is incorporated herein by reference as if set forth in full.

### BACKGROUND

In the realm of complex computing systems, the incessant surge in data generation, coupled with increasingly powerful processing capabilities, demand continuous advancements in data transfer technology.

### BRIEF DESCRIPTION OF THE DRAWINGS

FIGS. 1-3 depict illustrative schematic diagrams for enhanced tunneled synchronization, in accordance with one or more example embodiments of the present disclosure.

FIG. 4 illustrates a flow diagram of a process for an enhanced tunneled synchronization system, in accordance with one or more example embodiments of the present disclosure.

FIG. 5 is a block diagram illustrating an example of a computing device or computing system upon which any of one or more techniques (e.g., methods) may be performed, in accordance with one or more example embodiments of the present disclosure.

FIG. 6 illustrates an embodiment of a block diagram for a computing system including a processor, in accordance with one or more example embodiments of the present disclosure.

FIG. 7 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Artificial intelligence (AI) and large language models (LLMs) have substantially increased the capacity and bandwidth requirements from CPUs or General-Purpose Graphics Processing Units (GPGPUs) attached memory. 100% read bandwidth has become more critical for generative AI based inference applications. In search of low latency, and low power methodology for driving the memory bandwidth higher, using LPDDR like memory devices with chip-to-chip interconnects has been explored. However, getting to 64 to 80 native memory channels escaping the CPU which have wide LPDDR interfaces are imposing excessive stress on package pin counts and signal integrity challenges that come along with it. These interfaces are also capped at top speed of operation as well as reach, thus not making efficient use of package pins.

The proposal outlined here provides one or more ways to map native memory protocol over two classes of Off-Package Interconnects:
1. serial, differential, point-to-point, full-duplex link (e.g., PCIe) capable of longer distance.
2. single-ended, point-to-point, full-duplex link (e.g., UCIe-based off-package) capable of a shorter distance.

Throughout this disclosure, PCIe will be referred to as an example of (1) and a UCIe-based Off-Package interconnect as an example of (2). Through these examples, it can be shown how to leverage UCIe-based Off Package Physical Layers OR PCIe SERDES Analog Front End (AFE) to send native memory protocols over to a Memory buffer chip to allow for scale up and scale out solutions for memory devices on the platform. SERDES stands for Serializer/Deserializer. It is a hardware interface that enables high-speed communication by converting data between parallel interfaces and serial interfaces.

Universal Chiplet Interconnect Express (UCIe) is an industry standard pivotal in the evolution of integrated circuit design. It establishes protocols for chiplets—small blocks of integrated circuits—to interconnect within a single package. By leveraging standards like PCI Express (PCIe) and Compute Express Link (CXL), UCIe facilitates die-to-die serial connections that enable these chiplets to communicate effectively. The aim is to provide a scalable solution for creating larger, more complex System-on-Chips (SoCs) that go beyond the constraints of maximum reticle size. With UCIe, manufacturers gain the flexibility to combine chiplets from various sources, paving the way for more modular and easily upgradeable SoCs.

Example embodiments of the present disclosure relate to systems, methods, and devices for memory protocols over off-package interconnects.

In one embodiment, an enhanced tunneled synchronization system may establish memory protocol mapping over efficient high-speed off package Links. These could be:
1. serial, differential, point-to-point, full-duplex link (e.g., PCIe) capable of longer distance.
2. single-ended, point-to-point, full-duplex link (e.g., UCIe-based off-package) capable of a shorter distance.

For both scenarios:
1) This disclosure presents a concept around mapping native memory protocols into Flits which can be sent over PCIe SERDES Analog Front End (AFE) OR wire mapping for UCIe-based Off Package pins.
2) Asymmetric lanes in Tx and Rx from and to SoC to optimize pin count, power for memory applications. Data and commands sent on different lanes from SoC, so that it is possible to also provide asymmetric L0p feature in the case of PCIe SERDES to optimize power for 100% read bandwidth, as well as have lesser overhead of packing/unpacking Flits in terms of latency additions.
3) Leverage PCIe FEC and CRC to provide protection for Link transport as well as metadata/ECC for memory array for PCIe SERDES. In the case of UCIe-based PHY, leverage the UCIe CRC
4) A memory buffer chip with PCIe AFE OR UCIe-based PHY on the SoC side, and one or more memory PHYs on the other side—this serves as the expansion chip to fanout to multiple Memory devices. It is also permitted for this to be integrated into the memory device itself (examples: HBM-like logic die, LPDDR CAMM or DDR DIMM).
5) A mechanism to send configuration requests, management or error notification packets to configure the memory buffer and/or memory device, as well as error collection/notification from the device to SoC.

Scalable memory fanout solution that leverages the high speeds (for example, 64 GT/s with PCIe 6.0), package pin efficiency as well as longer reach on the platform allowing for platform layout flexibility.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

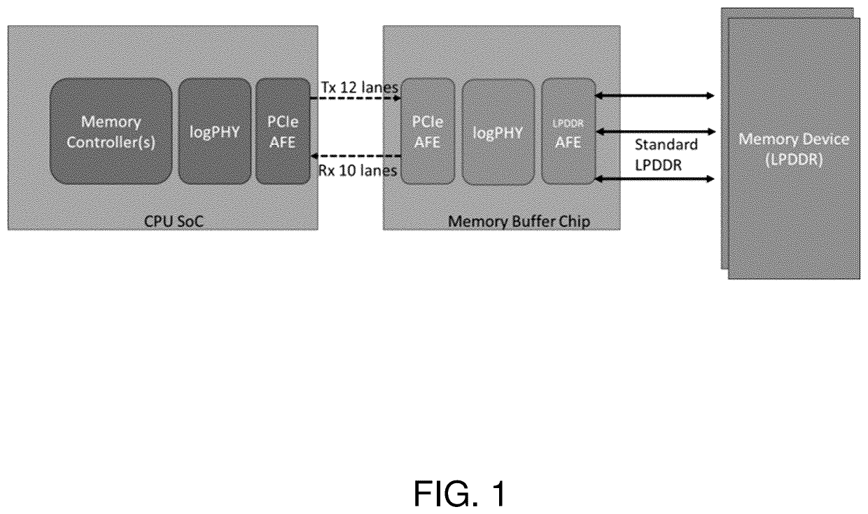

FIGS. 1-3 depict illustrative schematic diagrams for enhanced tunneled synchronization, in accordance with one or more example embodiments of the present disclosure.

FIG. 1 shows an example illustrating the application of this technique to LPDDR using PCIe AFE (SERDES). The Memory Buffer Chip provides fanout to one or more LPDDR5 Memory device chips. One or more memory controllers multiplex the memory commands on the PCIe SERDES to send it to the Memory Buffer Chip. Note that the proposal would work regardless of the memory technology, since the expectation is that the Memory buffer chip is providing the translation from PCIe SERDES to Memory PHY.

In one or more embodiments, the system employs a memory buffer chip that receives multiplexed memory commands from multiple memory controllers over PCIe SERDES lanes and distributes these commands to various LPDDR5 memory devices. For example, a server platform may use a single memory buffer chip to fan out requests from two different CPUs to four separate LPDDR5 DRAM modules, allowing efficient sharing and higher memory bandwidth without requiring each CPU to connect directly to every memory device.

In one or more embodiments, the translation function within the memory buffer chip is designed to adapt to different memory technologies. For example, the same memory buffer chip may be configured to work with LPDDR5, DDR5, or future memory standards by updating its firmware or hardware logic to support the respective memory PHY protocols. This flexibility enables manufacturers to design platforms that are easily upgradable to newer generations of memory devices.

In one or more embodiments, the use of PCIe SERDES for memory command and data transport provides scalability and platform design flexibility. For example, a data center system can leverage long-reach PCIe connections to place memory devices farther from the central processor, optimizing board layout and enabling higher density memory expansion without significant signal integrity issues. This architectural choice allows for larger memory pools and supports evolving memory requirements in high-performance computing environments.

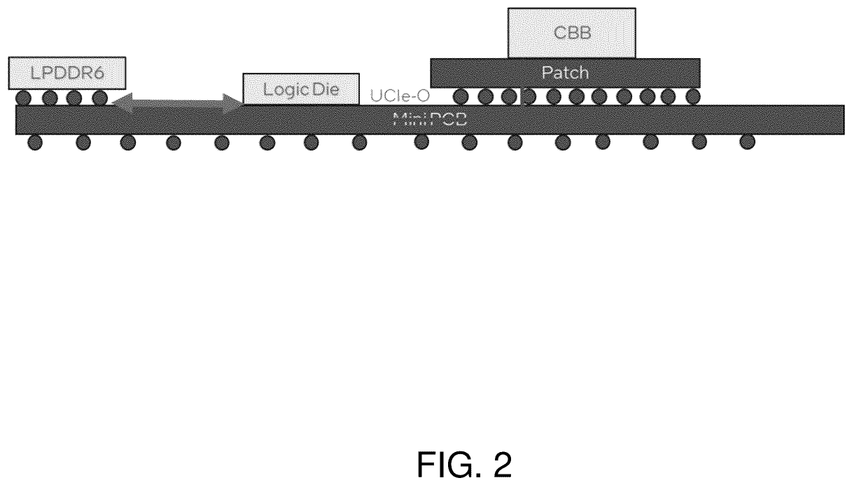

Referring to FIG. 2, there is shown an example illustration of LPDDR6 using UCIe-based Off package interconnect over bottom side BGA pins.

FIG. 2 shows an example illustrating the application of this technique to LPDDR6 using a UCIe-based Off package interconnect (annotated as UCIe-O in FIG. 2). In this context, “UCIe-based Off package interconnect” refers to a high-speed communication link that connects components located in different physical packages, allowing flexible system integration and extended reach. For short-reach off-package interconnects, multiple packaging options are possible (such as bottom side BGA, top-side wirebond etc.), and there is significant benefit in all cases, however for comparison purposes, it is suggested to use bottom side BGA with interposer (with a 0.6 mm pitch estimate). The “Logic Die” shown in the picture serves as the memory buffer chip, which acts as a bridge, translating signals and protocols between the SoC and memory devices to ensure compatibility. As mentioned previously, this could be co-located with the memory devices (such as on the CAMM), or it could be soldered down on the package as shown in FIG. 2. CBB is referring to the SoC die containing the memory controller for the purposes of this disclosure; in other words, CBB is the central processing unit's chip responsible for issuing commands to the memory subsystem.

For the PCIe SERDES based applications:
1) Mapping to PCIe lanes:
a. Asymmetry: In this context, the memory controller sends commands to the memory device, so command information only needs to travel from the CPU SoC to the memory device and not in the opposite direction. This setup allows for power and pin savings by designing the communication link to be asymmetric. For example, in the LPDDR5 case, the system uses 8 lanes to send data, 2 lanes to send commands, and 2 lanes for PCIe encapsulation, error correction, and memory metadata. This allocation maintains a command to data bandwidth ratio of 1:4, meaning for every command sent, four units of data are transmitted. The encapsulation lanes carry the Flit header, Replay information, CRC bytes, FEC bytes, and any required memory metadata, which supports error correction and replay functionalities at the protocol level. This results in a total of 12 lanes used from the SoC to the memory buffer chip.

For the reverse direction—from the memory buffer chip back to the SoC—the communication needs are different. Here, only data and protocol-related information need to be transmitted because command bytes are not needed. For example, the system allocates 8 lanes for transferring data and 2 lanes for PCIe encapsulation, error correction, and memory metadata. This setup totals 10 lanes in the direction from the memory buffer chip to the SoC.

This arrangement provides benefits in terms of efficiency and scalability. For example, it allows designers to optimize how many physical pins are required on chips and how much power is consumed for each direction of communication. By splitting lane allocation based on actual data transfer needs, higher overall bandwidth and lower power consumption can be achieved, supporting the demands of platforms like server systems or high-performance computing devices where memory expansion and data integrity are crucial.

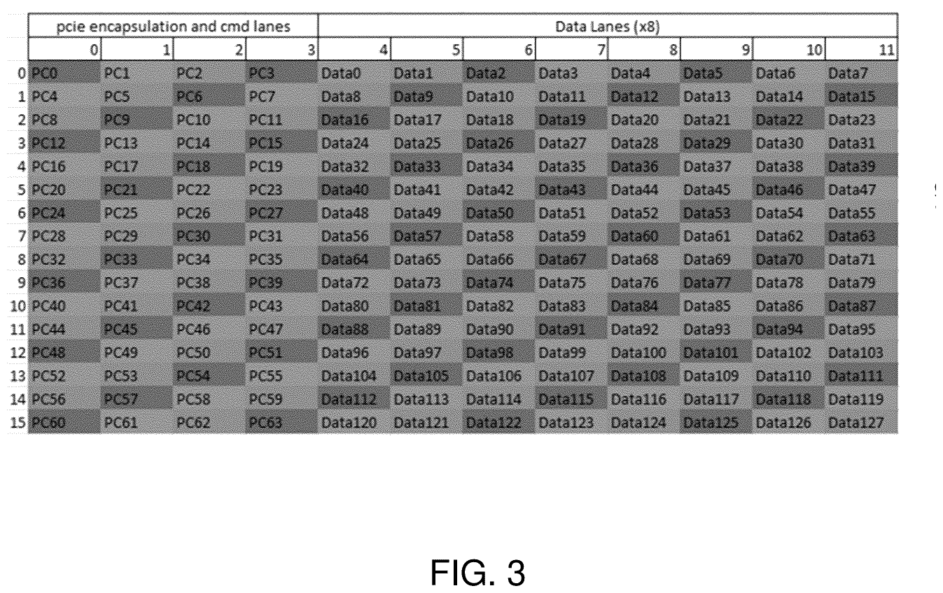

Referring to FIG. 3, there is shown an example byte arrangement of a 192B Flit for the LPDDR5 example for 12 lanes (SoC->Mem). FIG. 3 illustrates the byte organization for the SoC to Memory direction, where each box represents a byte and different FEC groups are indicated by their placement. PC* are the PCIe encapsulation and Command bytes, Data* are the data bytes. It should be understood that “*” represents the variable numbers after PC and Data as depicted in FIG. 3.
b. Error correction and replay leveraged from PCIe 6.0: The system uses FEC and CRC encapsulation to safeguard not only command and data bytes but also associated metadata during transmission. Specifically, 6 bytes of CRC are applied for every 96 bytes within the Flit, ensuring that any errors during communication can be detected and corrected. Replay operations are managed over 256 bytes of the Flit, allowing the system to resend specific data segments if transmission issues are detected. The Flit Header contains details indicating whether the Flit includes data bytes; if there are no data bytes present, a value of zero is used for FEC and CRC calculations. This process ensures all ECC and metadata bits stored in the memory device are protected during transmission. For example, during memory read or write commands sent over PCIe lanes, if the system detects an error using the CRC check, it can automatically trigger a replay of the affected segment using the replay protocol. This ensures data integrity between the SoC and memory buffer chip. Additionally, when a Flit transmits only command and metadata bytes without carrying any user data, the system still applies FEC and CRC so that any non-data information also remains protected against transmission errors.
c. Power savings for 100% read bandwidth: Provide asymmetric L0p support such that only command lanes and PCIe encapsulation lanes are active in the SoC to memory direction. This means that, when the system is handling entirely read-based traffic, fewer lanes are used for sending commands from the SoC to the memory device, while the lanes dedicated to returning data from memory to the SoC remain fully active. For example, in the LPDDR5 case, if a server is reading large amounts of data from memory, only 4 out of 12 lanes are utilized to send necessary commands and control signals from the SoC to the memory, thereby saving power. Meanwhile, all 10 lanes from memory to SoC are used for transmitting the actual read data and related protocol information, ensuring high throughput for memory reads. The handshakes, which control transitions into and out of the low-power L0p state, are managed independently for each direction of traffic. For example, when the SoC is not sending write commands or only performing reads, it can quickly enter the low-power L0p state in the SoC to memory direction, reducing power consumption without affecting the active state of the memory to SoC direction. This independent handling results in faster and more efficient transitions between active and low-power modes, which is particularly useful in real-time high-performance computing scenarios, such as data centers processing large database queries where read operations dominate.
2) Memory Buffer Chip: This chip is responsible for converting PCIe signal formats on one side to Memory PHY timings on the other side, ensuring that data can move smoothly between different interfaces. For example, if data is received as a PCIe packet from the SoC, the Memory Buffer Chip translates it into the signaling format needed by the attached memory modules, allowing the memory to correctly interpret and store the data. This chip can either be implemented as a separate, standalone component on the platform that connects to multiple memory DIMMs, or integrated directly into a memory device, such as an HBM-like stacked memory module, which contains several layers of memory arrays. The Memory Buffer Chip also manages memory-specific timing requirements. For example, if a particular memory module requires a specific signal delay to operate correctly, the chip ensures these timing parameters are met. It performs FEC and CRC checks, which are used for error detection and correction in PCIe data packets. For instance, when a data packet arrives from the SoC, the Memory Buffer Chip checks for errors using FEC algorithms, and validates data integrity with CRC bits, before passing the data to the memory. In addition, the chip may include logic to handle situations where parts of the memory array fail. For example, if a memory bank develops persistent errors, the Memory Buffer Chip can remap the failed bank to a spare location within the memory array, thereby maintaining system reliability and performance. Similarly, the chip can facilitate memory failover scenarios, where data is redirected to backup banks in the event of hardware issues. These features ensure robust and error-resilient memory operations in high-performance computing environments.
3) Configuration, management and error notification messages: There are several options for tunneling configuration requests and Error notification messages on the Link.
a. Option1: A dedicated encoding is used from the command bytes, and the corresponding data bytes carry the relevant configuration, error or management packet. For the Memory to SoC direction, there are no command bytes, and so could use a special Flit Header encoding for this purpose.

In a computing context where data is transferred from memory to a System on Chip (SoC), the term “command bytes” denotes a sequence of instructions directed towards memory modules. These bytes are crucial as they dictate the operations to be executed, such as reading from or writing to the memory. When data is headed from the memory to the SoC, the absence of command bytes necessitates a different data handling mechanism. This is where a “special Flit Header” becomes essential. A Flit, shorthand for flow control digit, represents a fundamental transfer unit within certain high-speed data communication protocols and network-on-chip architectures. A Flit Header, therefore, comprises the initial part of this data packet, encapsulating control and routing information. Given this setup, when command bytes are not part of the transmission, a unique encoding system within the Flit Header is employed specifically for this scenario. This specialized encoding ensures that even without command bytes, the data is correctly interpreted and processed upon reception by the SoC. The special Flit Header's unique design creates an efficient and error-free data communication methodology between memory and the SoC.
b. Option2: Skip Ordered Sets (SOS) are sent at regular intervals in PCIe analog front end (AFE), it is possible to tunnel these packets in the SOS commands.
c. Option3: have dedicated space in the Flit (similar to DLLP bytes in PCIe) for these packets.

For the UCIe based Off Package applications:
1) Mapping to the UCIe pins: Table shown below gives the mapping. For every 12 lanes dedicated to data transfer, 2 command pins are allocated, and these connect to specific sets of memory channels or devices. This design allows the same group of command and data lanes to be shared among several memory devices or channels through time multiplexing. For example, if a system has 24 data lanes and 4 command pins, it can dynamically switch which memory modules these pins communicate with depending on workload demands.

As shown in the table below, there are 8 command lanes available. This setup enables up to 4 independent memory channel groups to operate at the same time. For example, three groups can be assigned to read operations using 36 data lanes (12 lanes per group), and one group can be set for write operations with its own dedicated 12 data lanes. This means the system can handle multiple read and write operations in parallel, improving overall performance.

As faster data rates are pursued for off-package links, certain lanes are specifically assigned for FEC and CRC. For example, the FEC algorithm used might follow the structure established in PCIe, and CRC methods could adhere to the specifications from UCIe. These features help catch and correct errors in data transmission, which is crucial for maintaining data integrity at high speeds. For example, if a data transmission error is detected using CRC, the system can use the error information from FEC to correct the affected bits on the fly, ensuring reliable communication between the SoC and the memory devices.

There are also 2 dedicated pins for UCIe-sideband per direction which operate at a much lower data rate; these are not shown in the table.

TABLE 1
Mapping to UCIe-O pins

| | SoC−>Memory Buffer | | Memory Buffer −> SoC |
|---|---|---|---|
| Command | 8 | — | — |
| Data | 12 | Data | 36 |
| Clock | 2 | Clock | 2 |
| Track | 1 | Track | 1 |
| Valid | 1 | Valid | 1 |
| FEC | 1 | FEC | 1 |
| CRC | 1 | CRC | 1 |
| Total | 26 | | 42 |

2) Memory Buffer Chip or Logic Die: This helps translate the UCIe encapsulation on one side to Memory PHY timings on the other side and vice-versa. It also handles memory training protocol. It can be a discrete chip on the platform providing fanout to multiple memory DIMMs, OR, it can be an integrated die within a memory device (HBM-Like for example) which has multiple stacked arrays of memory. It implements the associated intelligence related to specific memory timing requirements as well as FEC/CRC checks needed for UCIe encapsulation. It is also permitted to have logic to handle memory failover scenarios and remap banks in case of persistent failures in the memory array.
3) Configuration, management and error notification messages: These would be handled using the UCIe-sideband protocol and can leverage all the mechanisms described in the UCIe specification.

For faster detection of runtime error alerts (CRC error on the receiving end of the Memory buffer for example), the following mechanisms can be deployed:
a. Corrupt CRC for any ongoing traffic from the Memory Buffer to SoC.
b. If there is no ongoing traffic, a special encoding used on the Valid Lane can indicate that an error occurred, and the memory controller must replay traffic from a fixed time window prior to the error detection. Normally, the valid lane transfers an encoding of 0000_1111b for valid transfers, but it could use a special encoding of 0011_0011b for error alert notification.

Tables 2 and 3 below show the comparison of the different options for different key performance indicators, assuming 1.5 TB/s of bandwidth target from the SoC to the memory devices. The additional Platform power is due to the presence of the Memory Buffer (or Logic Die), however, since that is closer to the memory, overall thermal dissipation improves from the CPU perspective in the case of the UCIe-based off package interconnect. The KPI for the UCIe Off Package in terms of power/speed are targets for a future generation of the Physical Layer.

TABLE 2

| | DMR-XP | | NVLink | | UCIe Off | | PCIe | |
|---|---|---|---|---|---|---|---|---|
| | LPDDR PHY | | C2C | | Package | | SERDES | |
| Power | 2.8 | pJ/b* | 1.3 | pJ/b | 1 | pJ/b | 4.5 | pJ/b |
| Speed | 9.6 | GT/s | 40 | GT/s | 50 | GT/s | 128 | GT/s |
| Reach | ~6 | inch | ~3 | inch | 3-4 | inch | 12 | inch |

TABLE 3

| | DMR-XP | UCIe Off | | | |
|---|---|---|---|---|---|
| KPI | LPDDR PHY | Package | | PCIe SERDES | |
| Latency Impact (roundtrip) | Baseline | +~4 | ns | +~10 | ns |
| Package pin area for 1.5 TB/s | 2131.2 sqmm | 353.9** | sqmm | 1049.8 | sqmm |
| (assuming square pattern for | | | | | |
| simplicity) | | | | | |

| | | | |
|---|---|---|---|
| CPU Power for 100% Read | Baseline* | −11 W (power | +10 W (power |
| | | reduction) | addition) |
| Platform Power | Baseline* | +13 W (power | +55 W (power |
| | | addition) | addition) |
| Platform Reach (Flexibility) | Baseline | Ideal with | Ideal if we want |
| | | interposer (see | socket plug/play |

slide 6, 7)

| | | | |
|---|---|---|---|
| IP Readiness | Baseline | Needs new UCIe | Needs asymmetric version of |
| | | Off Package PHY | 128 GT/s PHY of PCIe |

optimized for memory

Conservative comparison, as LPDDR number accounts for power per data transfer, but other numbers are taking raw transfer (1.25× worse).
Assuming 0.6 mm bump pitch.

It is understood that the above descriptions are for the purposes of illustration and are not meant to be limiting.

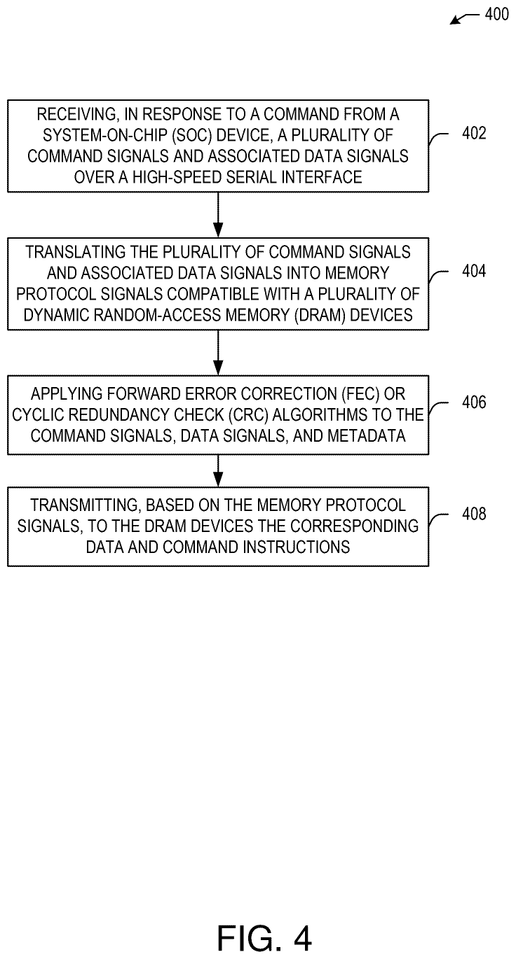

FIG. 4 illustrates a flow diagram of illustrative process 400 for an enhanced tunneled synchronization system, in accordance with one or more example embodiments of the present disclosure.

At block 402, a device may receive based on a command from a system-on-chip (SoC) device, at a memory buffer die, a plurality of command signals and associated data signals over a high-speed serial interface.

At block 404, the device may translate the plurality of command signals and associated data signals, at the memory buffer die, into memory protocol signals compatible with a plurality of dynamic random-access memory (DRAM) devices.

At block 406, the device may apply forward error correction (FEC) and cyclic redundancy check (CRC) algorithms to the command signals, data signals, and metadata at the memory buffer die.

At block 408, the device may transmit based on the memory protocol signals, from the memory buffer die to the DRAM devices, the corresponding data and command instructions.

In one or more embodiments, a device or a system may include memory buffer circuitry configured to translate protocol-specific units received over an off-package interconnect into timings compatible with one or more memory device protocols. This may help ensure seamless communication between different types of memory devices and interconnect standards, improving overall system flexibility. For example, a device may translate PCIe-encapsulated flits into DRAM-compatible protocol signals, addressing interoperability challenges.

In one or more embodiments, the device may comprise logic within the memory buffer circuitry to handle memory failover scenarios and remap memory banks in response to persistent failures. This may provide enhanced reliability for systems where high availability is critical, such as in enterprise servers. For instance, the device may detect errors in a memory bank and automatically redirect operations to a healthy bank without system downtime.

In one or more embodiments, the off-package interconnect may support detection of runtime error alerts by transmitting special encoding on a valid lane in the absence of ongoing traffic. This may enable rapid notification of errors, allowing for quicker response and reduced risk of data loss. As an example, the device may encode an alert on an unused lane when a runtime error is detected, facilitating immediate error handling.

In one or more embodiments, the off-package interconnect may include dedicated lanes or pins for forward error correction and cyclic redundancy check information. This may improve data integrity during transmission and help the system recover from transient faults. For example, separate lanes may be reserved for FEC and CRC data, ensuring error correction information is not mixed with regular traffic.

In one or more embodiments, the memory buffer circuitry may be implemented as a discrete chip on a platform providing fanout to multiple memory modules, or as an integrated die within a memory device. This may allow the system architect to select the approach best suited to the performance, cost, or integration needs of a particular application. In practice, a device may use a discrete buffer chip to connect multiple DRAM modules, optimizing scalability in data center hardware.

In one or more embodiments, the device may multiplex memory commands received from a memory controller over a high-speed serial interface. This may increase command throughput and enable efficient utilization of serial bandwidth. For instance, the device may combine multiple commands into a single transmission, reducing latency in high-performance computing environments.

In one or more embodiments, the high-speed serial interface may comprise a PCIe physical layer, and the device may convert PCIe-encapsulated flits into DRAM-compatible protocol signals. This may address compatibility issues between computing platforms and memory technologies. An example implementation may involve translating PCIe traffic to DRAM instructions in real time.

In one or more embodiments, the device may distribute command and data signals to multiple DRAM devices via a fanout configuration implemented by the memory buffer die. This may support system expansion and improved resource sharing. For example, one device may simultaneously transmit instructions to several memory modules, enhancing parallelism.

In one or more embodiments, the device may implement asymmetric lane allocation, such that a different number of lanes are used for command signals and data signals in each direction. This may optimize bandwidth allocation and minimize bottlenecks. For instance, more lanes may be assigned for data going from the device to DRAM, while fewer lanes are used for commands.

In one or more embodiments, the device may handle error notification messages by encoding error alerts onto a valid lane of the high-speed serial interface when runtime errors are detected. This may assist with rapid error reporting and system resilience. As an example, the device may use a dedicated lane to send a CRC error message during ongoing traffic interruptions.

In one or more embodiments, the device may integrate the memory buffer die together with one or more DRAM devices in a single memory package. This may reduce latency and enhance the compactness of the memory subsystem. For instance, a mobile computing device may include DRAM and buffer logic on a single module to save space and improve speed.

It is understood that the above descriptions are for the purposes of illustration and are not meant to be limiting.

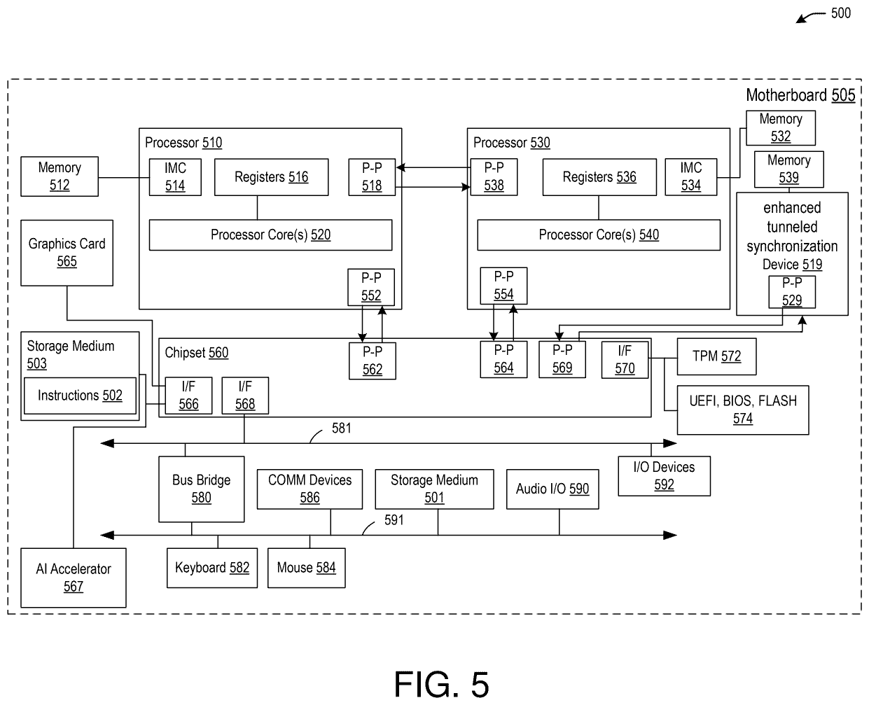

FIG. 5 illustrates an embodiment of an exemplary system 500, in accordance with one or more example embodiments of the present disclosure.

In various embodiments, the computing system 500 may comprise or be implemented as part of an electronic device.

The embodiments are not limited in this context. More generally, the computing system 500 is configured to implement all logic, systems, processes, logic flows, methods, equations, apparatuses, and functionality described herein.

The system 500 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 500 may have a single processor with one core or more than one processor. Note that the term “processor” refers to a processor with a single core or a processor package with multiple processor cores.

The computing system 500 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 500. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 500 comprises a motherboard 505 for mounting platform components. The motherboard 505 is a point-to-point interconnect platform that includes a processor 510, a processor 530 coupled via a point-to-point interconnects as an Ultra Path Interconnect (UPI), and an enhanced tunneled synchronization device 519. In other embodiments, the system 500 may be of another bus architecture, such as a multi-drop bus. Furthermore, each of processors 510 and 530 may be processor packages with multiple processor cores. As an example, processors 510 and 530 are shown to include processor core(s) 520 and 540, respectively. While the system 500 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 510 and the chipset 560. Some platforms may include additional components and some platforms may only include sockets to mount the processors and/or the chipset.

The processors 510 and 530 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 510, and 530.

The processor 510 includes an integrated memory controller (IMC) 514, registers 516, and point-to-point (P-P) interfaces 518 and 552. Similarly, the processor 530 includes an IMC 534, registers 536, and P-P interfaces 538 and 554. The IMC's 514 and 534 couple the processors 510 and 530, respectively, to respective memories, a memory 512 and a memory 532. The memories 512 and 532 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 512 and 532 locally attach to the respective processors 510 and 530.

In addition to the processors 510 and 530, the system 500 may include an enhanced tunneled synchronization device 519. The enhanced tunneled synchronization device 519 may be connected to chipset 560 by means of P-P interfaces 529 and 569. The enhanced tunneled synchronization device 519 may also be connected to a memory 539. In some embodiments, the enhanced tunneled synchronization device 519 may be connected to at least one of the processors 510 and 530. In other embodiments, the memories 512, 532, and 539 may couple with the processor 510 and 530, and the enhanced tunneled synchronization device 519 via a bus and shared memory hub.

System 500 includes chipset 560 coupled to processors 510 and 530. Furthermore, chipset 560 can be coupled to storage medium 503, for example, via an interface (I/F) 566. The I/F 566 may be, for example, a Peripheral Component Interconnect-enhanced (PCI-e). The processors 510, 530, and the enhanced tunneled synchronization device 519 may access the storage medium 503 through chipset 560.

It should be noted that PCIe, UCIe, and CXL are distinct standards in computing, each serving specific functions. PCIe, or Peripheral Component Interconnect Express, is a widely adopted serial computer expansion bus standard. It's integral for connecting high-speed components such as graphics cards, SSDs, and network cards to a motherboard, known for its scalability and efficient data transfer rates. Its point-to-point configuration reduces bottlenecks, making it highly effective. In contrast, UCIe, or Universal Chiplet Interconnect Express, is a more recent development. It standardizes the interconnect between chiplets within a single package. Chiplets are small, modular silicon blocks with specific functions, assembled to form a complex chip. UCIe's primary aim is to streamline chiplet communication, fostering the design and creation of more efficient and powerful processors through modular integration. CXL, or Compute Express Link, focuses on high-speed, low-latency connections between CPUs and various devices like workload accelerators, memory buffers, and smart I/O devices. While leveraging the PCIe interface for its physical and electrical aspects, CXL is tailored for advanced computing tasks requiring intensive data processing, such as AI and machine learning. Its ability to efficiently share memory among various components is a key feature, marking its importance in the realm of data-intensive computing. Together, these technologies represent the diverse needs and advancements in computer hardware, from general expansion capabilities to specialized data processing and modular chip design. PCIe's established presence contrasts with the emerging roles of UCIe and CXL, highlighting the dynamic and evolving nature of computer technology.

Storage medium 503 may comprise any non-transitory computer-readable storage medium or machine-readable storage medium, such as an optical, magnetic or semiconductor storage medium. In various embodiments, storage medium 503 may comprise an article of manufacture. In some embodiments, storage medium 503 may store computer-executable instructions, such as computer-executable instructions 502 to implement one or more of processes or operations described herein, (e.g., process XZY00 of FIG. XZY). The storage medium 503 may store computer-executable instructions for any equations depicted above. The storage medium 503 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 510 couples to a chipset 560 via P-P interfaces 552 and 562 and the processor 530 couples to a chipset 560 via P-P interfaces 554 and 564. Direct Media Interfaces (DMIs) may couple the P-P interfaces 552 and 562 and the P-P interfaces 554 and 564, respectively. The DMI may be a high-speed interconnect that facilitates, e.g., eight Giga Transfers per second (GT/s) such as DMI 3.0. In other embodiments, the processors 510 and 530 may interconnect via a bus.

The chipset 560 may comprise a controller hub such as a platform controller hub (PCH). The chipset 560 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 560 may comprise more than one controller hub such as a chipset with a memory controller hub, a graphics controller hub, and an input/output (I/O) controller hub.

In the present embodiment, the chipset 560 couples with a trusted platform module (TPM) 572 and the UEFI, BIOS, Flash component 574 via an interface (I/F) 570. The TPM 572 is a dedicated microcontroller designed to secure hardware by integrating cryptographic keys into devices. The UEFI, BIOS, Flash component 574 may provide pre-boot code.

Furthermore, chipset 560 includes the I/F 566 to couple chipset 560 with a high-performance graphics engine, graphics card 565. In other embodiments, the system 500 may include a flexible display interface (FDI) between the processors 510 and 530 and the chipset 560. The FDI interconnects a graphics processor core in a processor with the chipset 560.

Various I/O devices 592 couple to the bus 581, along with a bus bridge 580 which couples the bus 581 to a second bus 591 and an I/F 568 that connects the bus 581 with the chipset 560. In one embodiment, the second bus 591 may be a low pin count (LPC) bus. Various devices may couple to the second bus 591 including, for example, a keyboard 582, a mouse 584, communication devices 586, a storage medium 501, and an audio I/O 590.

The artificial intelligence (AI) accelerator 567 may be circuitry arranged to perform computations related to AI. The AI accelerator 567 may be connected to storage medium 503 and chipset 560. The Al accelerator 567 may deliver the processing power and energy efficiency needed to enable abundant-data computing. The AI accelerator 567 is a class of specialized hardware accelerators or computer systems designed to accelerate artificial intelligence and machine learning applications, including artificial neural networks and machine vision. The AI accelerator 567 may be applicable to algorithms for robotics, internet of things, other data-intensive and/or sensor-driven tasks.

Many of the I/O devices 592, communication devices 586, and the storage medium 501 may reside on the motherboard 505 while the keyboard 582 and the mouse 584 may be add-on peripherals. In other embodiments, some or all the I/O devices 592, communication devices 586, and the storage medium 501 are add-on peripherals and do not reside on the motherboard 505.

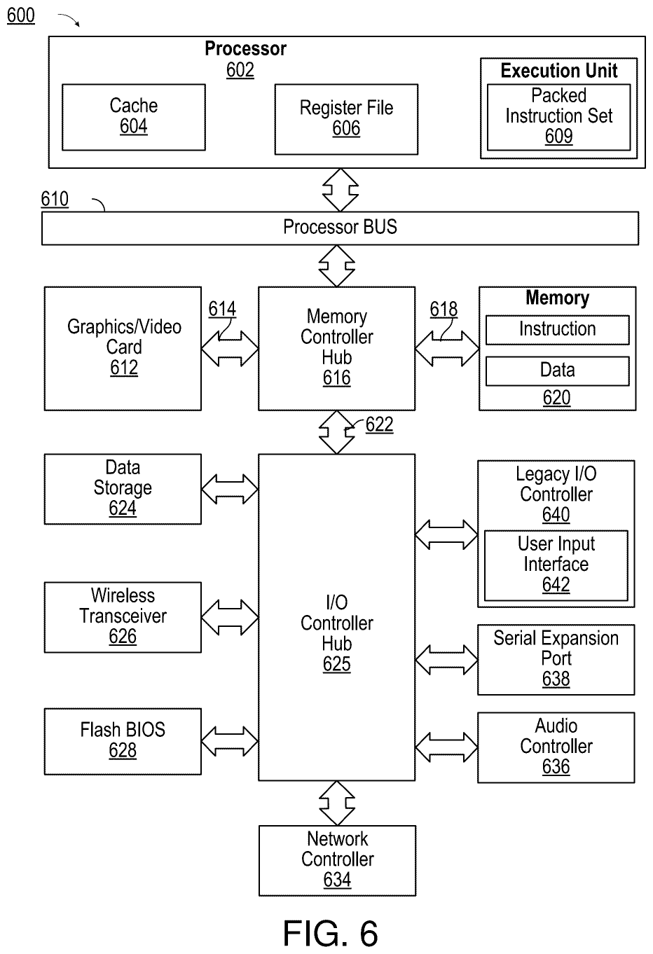

Turning to FIG. 6, a block diagram of an exemplary computer system formed with a processor that includes execution units to execute an instruction, where one or more of the interconnects implement one or more features in accordance with one embodiment of the present disclosure is illustrated. System 600 includes a component, such as a processor 602 to employ execution units including logic to perform algorithms for process data, in accordance with the present disclosure, such as in the embodiment described herein. In one embodiment, sample system 600 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 602 includes one or more execution units 608 to implement an algorithm that is to perform at least one instruction. One embodiment may be described in the context of a single processor desktop or server system, but alternative embodiments may be included in a multiprocessor system. System 600 is an example of a ‘hub’ system architecture. The computer system 600 includes a processor 602 to process data signals. The processor 602, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 602 is coupled to a processor bus 610 that transmits data signals between the processor 602 and other components in the system 600. The elements of system 600 (e.g. graphics accelerator 612, memory controller hub 616, memory 620, I/O controller hub 625, wireless transceiver 626, Flash BIOS 628, Network controller 634, Audio controller 636, Serial expansion port 638, I/O controller 640, etc.) perform their conventional functions that are well known to those familiar with the art.

In one embodiment, the processor 602 includes a Level 1 (L1) internal cache memory 604. Depending on the architecture, the processor 602 may have a single internal cache or multiple levels of internal caches. Other embodiments include a combination of both internal and external caches depending on the particular implementation and needs. Register file 606 is to store different types of data in various registers including integer registers, floating point registers, vector registers, banked registers, shadow registers, checkpoint registers, status registers, and instruction pointer register.

Execution unit 608, including logic to perform integer and floating point operations, also resides in the processor 602. The processor 602, in one embodiment, includes a microcode (ucode) ROM to store microcode, which when executed, is to perform algorithms for certain macroinstructions or handle complex scenarios. Here, microcode is potentially updateable to handle logic bugs/fixes for processor 602. For one embodiment, execution unit 608 includes logic to handle a packed instruction set 609. By including the packed instruction set 609 in the instruction set of a general-purpose processor 602, along with associated circuitry to execute the instructions, the operations used by many multimedia applications may be performed using packed data in a general-purpose processor 602. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 608 may also be used in micro controllers, embedded processors, graphics devices, DSPs, and other types of logic circuits. System 600 includes a memory 620. Memory 620 includes a dynamic random access memory (DRAM) device, a static random access memory (SRAM) device, flash memory device, or other memory device. Memory 620 stores instructions and/or data represented by data signals that are to be executed by the processor 602.

Note that any of the aforementioned features or aspects of the present disclosure and solutions may be utilized on one or more interconnect illustrated in FIG. 6. For example, an on-die interconnect (ODI), which is not shown, for coupling internal units of processor 602 implements one or more aspects of the embodiments described above. Or the embodiments may be associated with a processor bus 610 (e.g. other known high performance computing interconnect), a high bandwidth memory path 618 to memory 620, a point-to-point link to graphics accelerator 612 (e.g. a Peripheral Component Interconnect express (PCIe) compliant fabric), a controller hub interconnect 622, an I/O or other interconnect (e.g. USB, PCI, PCIe) for coupling the other illustrated components. Some examples of such components include the audio controller 636, firmware hub (flash BIOS) 628, wireless transceiver 626, data storage 624, legacy I/O controller 640 containing user input and keyboard interfaces 642, a serial expansion port 638 such as Universal Serial Bus (USB), and a network controller 634. The data storage device 624 can comprise a hard disk drive, a floppy disk drive, a CD-ROM device, a flash memory device, or other mass storage device.

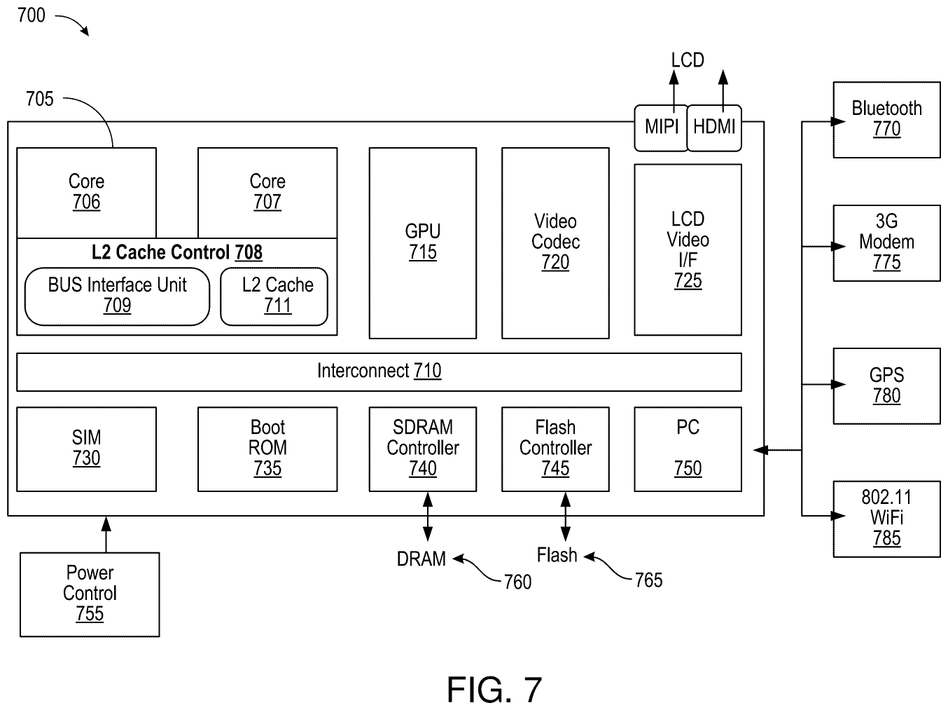

Turning next to FIG. 7, an embodiment of a system on-chip (SOC) design in accordance with the above disclosure is depicted. As a specific illustrative example, SOC 700 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 700 includes 2 cores—706 and 707. Similar to the discussion above, cores 706 and 707 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 706 and 707 are coupled to cache control 708 that is associated with bus interface unit 709 and L2 cache 711 to communicate with other parts of system 700. Interconnect 710 includes an on-chip interconnect, such as an IOSF, AMBA, or other interconnect discussed above, which potentially implements one or more aspects described herein.

Interface 710 provides communication channels to the other components, such as a Subscriber Identity Module (SIM) 730 to interface with a SIM card, a boot ROM 735 to hold boot code for execution by cores 706 and 707 to initialize and boot SOC 700, a SDRAM controller 740 to interface with external memory (e.g. DRAM 760), a flash controller 745 to interface with non-volatile memory (e.g. Flash 765), a peripheral control 750 (e.g. Serial Peripheral Interface) to interface with peripherals, video codecs 720 and Video interface 725 to display and receive input (e.g. touch enabled input), GPU 715 to perform graphics related computations, etc. Any of these interfaces may incorporate aspects of the embodiments described herein.

In addition, the system illustrates peripherals for communication, such as a Bluetooth module 770, 3G modem 775, GPS 780, and WiFi 785. Note as stated above, a UE includes a radio for communication. As a result, these peripheral communication modules are not all required. However, in a UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

The term “processor” as used herein refers to any device or circuitry capable of interpreting and executing program instructions. A processor may include, but is not limited to, a central processing unit (CPU), a graphics processing unit (GPU), a digital signal processor (DSP), a microcontroller, or an application-specific integrated circuit (ASIC). The processor may be implemented as a single component or as a plurality of components operatively coupled to achieve the desired processing functionality.

The term “memory” as used herein encompasses all forms of volatile and non-volatile storage accessible to a processor for storing data and program code. Memory may include, without limitation, random access memory (RAM), read-only memory (ROM), cache memory, flash memory, hard disk drives, solid-state drives, optical media, and any other suitable storage medium. Memory may reside locally within a device or be distributed across multiple systems or networks.

As used herein, the term “logic circuitry” is intended to refer to the combination of hardware elements, or hardware elements in conjunction with code, that implement one or more logical or functional operations within a system. Logic circuitry may include discrete electrical components, programmable logic devices, integrated circuits, or a combination thereof. Logic circuitry may be configured to perform specific tasks through fixed hardware design, through software execution, or a hybrid approach involving both hardware and software resources.

The term “system bus” as used herein denotes the collection of communication pathways that interconnect components within a processing system, enabling the transfer of instructions, data, and signals among processors, memory, peripheral interfaces, and other system elements. The system bus may include address, data, and control lines, and may be implemented using parallel, serial, or wireless technologies. The term “bus” may also encompass specialized interconnects such as peripheral component interconnect (PCI), universal serial bus (USB), or other industry-standard and proprietary communication schemes.

The word “code” as employed herein is intended to broadly cover any set of instructions executable by a processor or logic circuitry. Code may encompass applications, libraries, routines, drivers, firmware, microcode, modules, or any other construct by which a system may perform programmed operations. The code may be stored or transmitted in any suitable computer-readable medium or format, and may include both human-readable and machine-level representations.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware clement(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a system comprising a host device including processing circuitry, where the host device is configured to receive native memory protocol commands and associated data, encode the native memory protocol commands and associated data into protocol-specific units comprising Flits with error correction and/or metadata, and transmit the Flits over at least one off-package interconnect, as well as a memory including memory buffer circuitry configured to receive the Flits from the host device and decode the Flits to reconstruct original native memory protocol commands and associated data for delivery to one or more memory devices.

Example 2 may include the system of example 1, wherein the at least one off-package interconnect comprises a serial, differential, point-to-point, full-duplex link operable over a platform-level distance.

Example 3 may include the system of example 1, wherein the at least one off-package interconnect comprises a single-ended, point-to-point, full-duplex link operable over a short distance.

Example 4 may include the system of example 1, wherein encoding the received native memory protocol commands and associated data into Flits includes asymmetric lane assignment, with a different number of transmit lanes and receive lanes.

Example 5 may include the system of example 1, wherein each Flit comprises error correction codes comprising at least one of forward error correction and cyclic redundancy check.

Example 6 may include the system of example 1, wherein the processing circuitry is further configured to send configuration requests, management packets, or error notification packets to the memory buffer circuitry using dedicated Flit encodings.

Example 7 may include the system of example 1, wherein the memory buffer circuitry is configured to translate protocol-specific units received over the at least one off-package interconnect into timings compatible with one or more memory device protocols.

Example 8 may include the system of example 1, wherein the memory buffer circuitry handles memory failover scenarios and remaps memory banks in response to persistent failures.

Example 9 may include the system of example 1, wherein the off-package interconnect supports detection of runtime error alerts by transmitting special encoding on a valid lane in absence of ongoing traffic.

Example 10 may include the system of example 1, wherein the at least one off-package interconnect comprises dedicated lanes or pins for forward error correction and cyclic redundancy check information.

Example 11 may include the system of example 1, wherein the memory buffer circuitry is implemented as a discrete chip on a platform providing fanout to one or more memory circuitry, or as an integrated die within a memory device.

Example 12 may include a memory system comprising processing circuitry coupled to storage, the processing circuitry configured to receive, based on a command from a system-on-chip device, at a memory buffer die, a plurality of command signals and associated data signals over a high-speed serial interface, translate the plurality of command signals and associated data signals at the memory buffer die into memory protocol signals compatible with a plurality of dynamic random-access memory devices, apply forward error correction and cyclic redundancy check algorithms to the command signals, data signals, and metadata at the memory buffer die, and transmit, based on the memory protocol signals, from the memory buffer die to the dynamic random-access memory devices, corresponding data and command instructions.

Example 13 may include the memory system of example 12, wherein the memory buffer die is configured to multiplex memory commands received from a memory controller over the high-speed serial interface.

Example 14 may include the memory system of example 12, wherein the high-speed serial interface comprises a PCIe physical layer and the translating comprises converting PCIe-encapsulated flits into dynamic random-access memory-compatible protocol signals.

Example 15 may include the memory system of example 12, wherein the transmitting comprises distributing command and data signals to multiple dynamic random-access memory devices via a fanout configuration implemented by the memory buffer die.

Example 16 may include the memory system of example 12, wherein the memory buffer die is further configured to implement asymmetric lane allocation such that a different number of lanes are used for command signals and data signals in each direction.

Example 17 may include the memory system of example 12, wherein the memory buffer die is configured to handle error notification messages by encoding error alerts onto a valid lane of the high-speed serial interface when runtime errors are detected.

Example 18 may include the memory system of example 12, wherein the memory buffer die is integrated together with one or more dynamic random-access memory devices in a single memory package.

Example 19 may include a method performed by a memory buffer die, comprising receiving, in response to a command from a system-on-chip device, a plurality of command signals and associated data signals over a high-speed serial interface, translating the plurality of command signals and associated data signals into memory protocol signals compatible with a plurality of dynamic random-access memory devices, applying forward error correction or cyclic redundancy check algorithms to the command signals, data signals, and metadata, and transmitting, based on the memory protocol signals, to the dynamic random-access memory devices corresponding data and command instructions.

Example 20 may include the method of example 19, further comprising multiplexing memory commands received from a memory controller over a high-speed serial interface.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system comprising:
a host device including processing circuitry, the host device configured to:
receive native memory protocol commands and associated data;
encode the native memory protocol commands and associated data into protocol-specific units comprising Flits, each Flit including error correction and/or metadata information; and
transmit the Flits over at least one off-package interconnect; and
a memory including memory buffer circuitry, the memory configured to:
receive the Flits from the host device using the off-package interconnect; and
decode the Flits to reconstruct original native memory protocol commands and associated data for delivery to one or more memory devices.

2. The system of claim 1, wherein the at least one off-package interconnect comprises a serial, differential, point-to-point, full-duplex link operable over a platform-level distance.

3. The system of claim 1, wherein the at least one off-package interconnect comprises a single-ended, point-to-point, full-duplex link operable over a short distance.

4. The system of claim 1, wherein encoding the received native memory protocol commands and associated data into Flits includes asymmetric lane assignment, with a different number of transmit lanes and receive lanes.

5. The system of claim 1, wherein each Flit comprises error correction codes comprising at least one of forward error correction and cyclic redundancy check.

6. The system of claim 1, wherein the processing circuitry is further configured to send configuration requests, management packets, or error notification packets to the memory buffer circuitry using dedicated Flit encodings.

7. The system of claim 1, wherein the memory buffer circuitry is configured to translate protocol-specific units received over the at least one off-package interconnect into timings compatible with one or more memory device protocols.

8. The system of claim 1, wherein the memory buffer circuitry handles memory failover scenarios and remap memory banks in response to persistent failures.

9. The system of claim 1, wherein the off-package interconnect supports detection of runtime error alerts by transmitting special encoding on a valid lane in absence of ongoing traffic.

10. The system of claim 1, wherein the at least one off-package interconnect comprises dedicated lanes or pins for forward error correction and cyclic redundancy check information.

11. The system of claim 1, wherein the memory buffer circuitry is implemented as a discrete chip on a platform providing fanout to one or more memory circuitry or as an integrated die within a memory device.

12. A memory system comprising processing circuitry coupled to storage, the processing circuitry configured to:
receive based on a command from a system-on-chip (SoC) device, at a memory buffer die, a plurality of command signals and associated data signals over a high-speed serial interface;
translate the plurality of command signals and associated data signals, at the memory buffer die, into memory protocol signals compatible with a plurality of dynamic random-access memory (DRAM) devices;
apply forward error correction (FEC) and cyclic redundancy check (CRC) algorithms to the command signals, data signals, and metadata at the memory buffer die; and
transmit based on the memory protocol signals, from the memory buffer die to the DRAM devices, corresponding data and command instructions.

13. The memory system of claim 12, wherein the memory buffer die is configured to multiplex memory commands received from a memory controller over the high-speed serial interface.

14. The memory system of claim 12, wherein the high-speed serial interface comprises a PCIe physical layer and the translating comprises converting PCIe-encapsulated flits into DRAM-compatible protocol signals.

15. The memory system of claim 12, wherein the transmitting comprises distributing command and data signals to multiple DRAM devices via a fanout configuration implemented by the memory buffer die.

16. The memory system of claim 12, wherein the memory buffer die is further configured to implement asymmetric lane allocation, such that a different number of lanes are used for command signals and data signals in each direction.

17. The memory system of claim 12, wherein the memory buffer die is configured to handle error notification messages by encoding error alerts onto a valid lane of the high-speed serial interface when runtime errors are detected.

18. The memory system of claim 12, wherein the memory buffer die is integrated together with one or more DRAM devices in a single memory package.

19. A method, performed by a memory buffer die, comprising:
receiving, in response to a command from a system-on-chip (SoC) device, a plurality of command signals and associated data signals over a high-speed serial interface;
translating the plurality of command signals and associated data signals into memory protocol signals compatible with a plurality of dynamic random-access memory (DRAM) devices;
applying forward error correction (FEC) or cyclic redundancy check (CRC) algorithms to the command signals, data signals, and metadata; and
transmitting, based on the memory protocol signals, to the DRAM devices corresponding data and command instructions.

20. The method of claim 19, further comprising multiplexing memory commands received from a memory controller over a high-speed serial interface.
